(19) United States
(12) Patent Application Publication
(10) Pub. No.: US 2006/0060397 A1
(43) Pub. Date: Mar. 23, 2006

(54) Method for setting the operating point of a drive train

(76) Inventors: Claus Bischoff, Stuttgart (DE); Marcus Schulz, Ludwigsburg (DE)

Correspondence Address: KENYON & KENYON LLP, ONE BROADWAY, NEW YORK, NY, 10004, US

(21) Appl. No.: 10/532,380

(22) PCT Filed: Jul. 25, 2003
(86) PCT No.: PCT/DE03/02516

§ 371 Date: Apr. 21, 2005

(30) Foreign Application Priority Data
Dec. 7, 2002 (DE) 102 57 285.2

(51) Int. Cl. B60K 6/00

(52) U.S. Cl. 180/65.2

(57) ABSTRACT

A method for setting the operating point of a drive train whose purpose is to provide a mechanical and an electrical power output. The appropriate characteristic map is selected from a plurality of characteristic maps on the basis of the required electrical power, and, from this characteristic map, the operating point is selected on the basis of a plurality of kinematic and/or dynamic degrees of freedom.

### FIELD OF THE INVENTION

The present invention is directed to a method for setting (adjusting) the operating point of a drive train whose purpose is to provide a mechanical and an electrical power output.

### BACKGROUND INVENTION

Typically, the drive train of a motor vehicle includes a combustion engine having two degrees of freedom (variables) which can be used to set the operating point of the combustion engine. For example, the speed of the combustion engine is the first degree of freedom, which is a kinematic degree of freedom. The desired torque of the combustion engine is the second degree of freedom, for example, which is a dynamic degree of freedom.

If the drive train of a motor vehicle has a hybrid drive, which includes one or more electric drives and one combustion engine, then the first degree of freedom can be the speed of the electric drive, and the second degree of freedom can be the speed of the combustion engine, for example.

The drive train can be both a serial, as well as a power take-off hybrid drive train. In addition, as a transmission, the drive train can include a continuously variable transmission (CVT).

In order to set or select the optimal operating point for the drive train that corresponds, for example, to the lowest possible fuel consumption, it is necessary, in this regard, to find the optimum value for the two degrees of freedom.

It is known from the related art, when determining the operating point of the drive train, to consider the entire drive power required for driving the motor vehicle in the form of a total drive power. The method for determining the optimal operating points, also referred to as operating strategy, specifies the speed and the torques of the individual power units, for example of the engine and the transmission, for this total drive power. Included in the total drive power are the required mechanical drive power and the on-board vehicle system power. It is disadvantageous that the power losses of the electrical machines present in the vehicle, that are likewise to be covered by the combustion engine, are not considered at all or are merely considered as estimated values. High-output electrical machines, in particular 42 V starter generators, as are provided in innovative on-board electrical systems, have power losses which, in part, are quite substantial and heavily dependent on the operating point. Known methods heretofore do not take the power losses of these electrical machines into consideration.

### SUMMARY OF THE INVENTION

An advantage of the method according to the present invention for setting the operating point of a drive train is that it also takes into consideration the electrical losses occurring in the on-board power supply.

Thus, in the method according to the present invention for setting the operating point of a drive train whose purpose is to provide a mechanical and an electrical power output, the appropriate characteristic map is selected from a plurality of characteristic maps on the basis of the required electrical power, and, from this characteristic map, the operating point is selected on the basis of a plurality of kinematic and/or dynamic degrees of freedom.

In one specific embodiment of the method according to the present invention, a control for an energy storage device supplies a parameter which is indicative of the condition of the energy storage device. The appropriate characteristic map is additionally selected on the basis of this parameter. This has the advantage of enabling the charge condition of the energy storage device, for example of the battery, to be considered as well.

One preferred variant of the method according to the present invention for setting the operating point of a drive train provides that the electrical power required by the power consumers and the electrical power demanded from or deliverable by the energy storage device be taken into consideration in order to determine the electrical power requirement.

In one embodiment of the method according to the present invention, the energy storage device is charged or discharged as a function of the characteristic map.

Moreover, in the method according to the present invention, the electrical power requirement may be assigned to a power stage, on whose basis the appropriate characteristic map is then selected.

To achieve the objective, the method according to the present invention also provides for the power stage to be selected on the basis of the condition of the energy storage device and/or on the basis of the level of the available voltage. In this way, additional general conditions, namely the level of the on-board voltage and the charge condition of the electrical energy storage device, may also be taken into consideration when selecting the operating point.

The method according to the present invention is advantageously employed in a motor vehicle.

It may be provided in the method according to the present invention for the first degree of freedom to be constituted of a variable that represents the speed of the motor vehicle.

It may additionally be provided in the method according to the present invention for the second degree of freedom to be constituted of a setpoint torque.

Another specific embodiment of the method according to the present invention provides that the drive train have a transmission, the transmission ratio being adjusted as a function of the operating point. It is thereby achieved that the transmission provides the optimal ratio.

Finally, one embodiment of the method according to the present invention provides that the drive train have an electric drive and an internal combustion drive, the torque or the speed of the internal combustion drive being specified as a function of the operating point, and the torque or the speed of the electric drive being specified as a function of the operating point. Thus, both the internal combustion drive, as well as the electric drive function optimally in a hybrid drive.

### BRIEF DESCRIPTION OF THE DRAWINGS

FIG. 1 shows, in the form of a three-dimensional diagram, a characteristic map including the resulting speed of an engine as a function of the vehicle speed and the torque.

FIG. 2 shows, in the form of a three-dimensional diagram, another characteristic map including the resulting speed of the engine as a function of the vehicle speed and the setpoint torque.

FIG. 3 illustrates, in the form of a block diagram, one possible specific embodiment of the method according to the present invention for setting the operating point.

FIG. 4 depicts, in the form of another block diagram, the structure of the operating strategy.

FIG. 5 schematically illustrates a drive train whose operating point may be set by employing the method according to the present invention.

### DETAILED DESCRIPTION

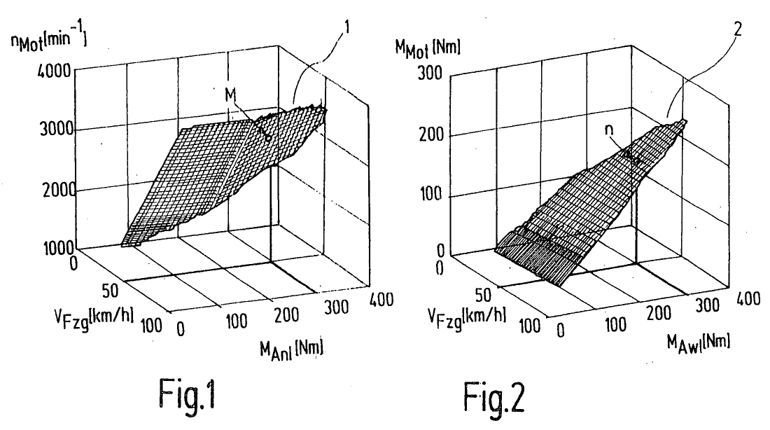

In the three-dimensional diagram shown in FIG. 1, desired torque MAwl is plotted on the axis extending to the right in the range from 0 to 400 Nm, and the speed of the vehicle vFzg is plotted on the axis extending to the left in the range from 0 to 100 km/h. Finally, the speed of engine nMot is represented on an axis ascending vertically, in the range from 1000 to 4000 revolutions per minute. On the basis of characteristic map 1 illustrated in FIG. 1, a speed of vFzg=50 km/h and a desired output torque MAwl=300 Nm, for example, yields an engine speed of nMot=3000 revolutions per minute.

Alternatively thereto, with the aid of characteristic map 2 illustrated in FIG. 2, engine torque MMot may also be determined as a function of speed vFzg of the vehicle and desired output torque MAwl. To this end in FIG. 2, on the second axis extending to the right, just as in FIG. 1, desired torque MAwl is plotted on the axis extending to the left, in the range from 0 to 400 Nm, and speed vFzg of the vehicle is plotted on the axis extending to the left, just as in FIG. 1, in the range from 0 to 100 km/h. However, on the vertically ascending axis, engine torque Mmot is shown in the range from 0 to 300 Nm. A vehicle speed of, for example, vFzg=50 km/h and a desired output torque of MAwl=300 Nm yields an engine torque of MMot=200 Nm

Characteristic maps calculated off-line are stored in the vehicle control. They assign control variables to a vehicle speed vFzg and to a desired output torque MAwl in order to optimize the operating characteristics of the drive train, and, additionally, cover the electrical losses occurring during conversion of the drive power, without loading the battery.
PeM1mech+PeM2mech+PeMlverl+PeM2verl=0 [symbol]
PBatterie=0

Where

PeM1mech=mechanical power of electrical machine 1;

PeM2mech=mechanical power of electrical machine 2;

PeM1verl=power loss of electrical machine 1; and

PeM2verl=power loss of electrical machine 2.

In addition to speed vFzg of the vehicle and desired output torque Mawl, the method according to the present invention takes into consideration power PBnz required by the on-board electrical system and a state variable bEnt, which will be discussed in greater detail further below. The electrical power balance is then calculated as:
PeM1mech+PeM2mech+PeM1verl+PeM2verl+PBnz=0

Electrical power PBnz required for the vehicle electrical system includes electrical power PVer demanded by the power consumers in the on-board electrical system and the power reserve of battery PBat. The operational sign of power reserve PBat depends on the charge condition of the battery. Thus, the need for the battery to be charged or discharged is reflected in power reserve PBat.
PBnz=PVer+PBat

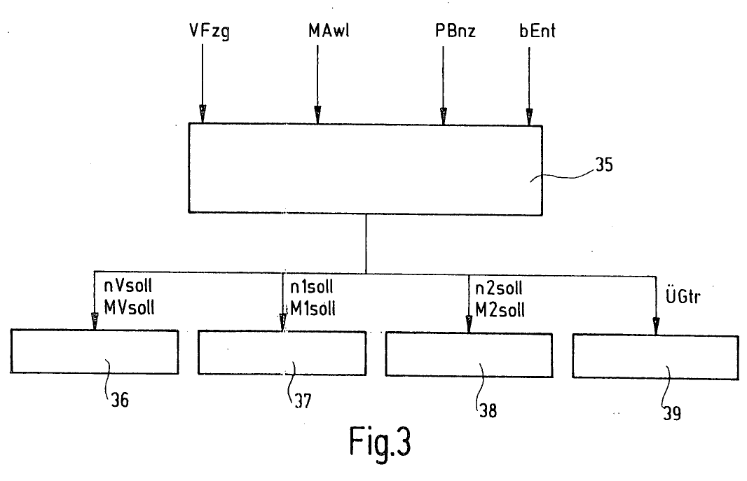

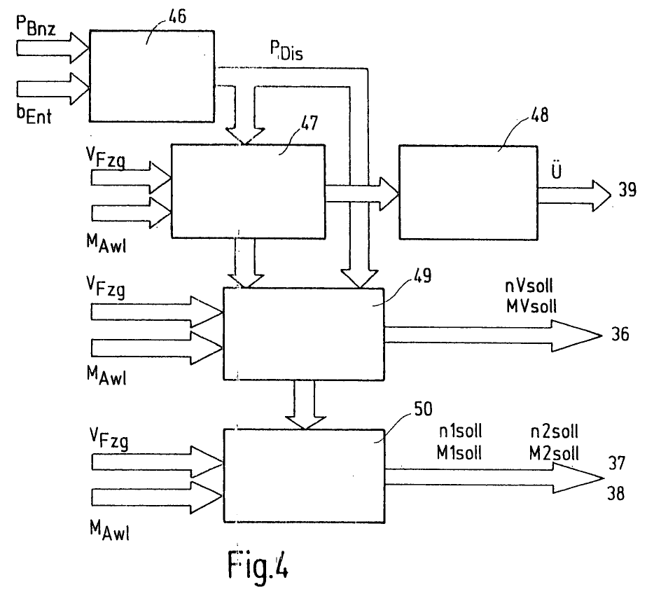

FIG. 3 illustrates, in the form of a block diagram, the basic principles of one possible specific embodiment of the method according to the present invention. On the basis of the variables, speed vFzg of the vehicle, desired output torque MAwl, required on-board power PBat and state variable bEnt, the map-based operating strategy characterized by block 35 determines the setpoint speed or the setpoint torque for combustion engine 36, electrical machine 1, electrical machine 2 and transmission 39. In FIG. 3, electrical machine 1 is characterized by reference numeral 37 and electrical machine 2 by reference numeral 38. Thus, map-based operating strategy 35 is used to specify setpoint speed nVsetpoint or setpoint torque MVsetpoint for combustion engine 36, setpoint speed nlsetpoint or setpoint torque M1setpoint for first electrical machine 37, setpoint speed n2setpoint or setpoint torque M2setpoint for second electrical machine 38 and setpoint ratio uGtr for transmission 39.

Typically, when controlling a vehicle, control characteristic maps having up to two continuous (infinitely variable) input variables are provided. For that reason, the method according to the present invention provides for control characteristic maps to be calculated for discrete on-board power demands (parameters of a family). To this end, a discretizer is provided in the control chain (loop) of the operating strategy; see FIG. 4. In accordance with a decision circuit bEnt, the discretizer assigns a discrete electrical setpoint power for the drive train to the active, continuous on-board power demand. For each discrete setpoint power, control maps are provided in the family of maps of the vehicle control which assign appropriate control variables to the drive train. The difference between on-board power demand PBnz and the discrete electrical setpoint power must be buffer-stored by the electrical energy storage device, for example in the form of a battery. High-capacity batteries, such as NiMH batteries, are particularly suited for this purpose. Their efficiency lies above 85 percent.

The structure of the operating strategy is shown in the form of a block diagram in FIG. 4. From the two input variables, namely required electrical power PBnz and state variable bEnt, discretizer 46 generates a discretized required electrical power PDis. The number of different available power stages PDis depends on the technical boundary conditions. With the aid of families of shift maps 47, setpoint ratio uGtr for transmission 39 is determined from discretized power PDis, together with speed vFzg and desired output torque MAwl and a subsequent ratio release. On the basis of families of shift maps 47, discretized electrical power PDis, speed vFzg and desired output torque Mawl, setpoint speed nVsetpoint or setpoint torque MVsetpoint for combustion engine 36 is determined by families of control maps in block 49. Finally, with the aid of families of control maps for the combustion engine, with the aid of speed vFzg and desired output torque Mawl, setpoint speeds n1setpoint and n2setpoint or setpoint torques Mlsetpoint and M2setpoint for the two electrical machines 37 and 38 are determined from the coupling conditions for the drive train.

The signal flow within the structure is described as follows.

a) The discretizer converts the continuous on-board setpoint power PBnz in accordance with decision selection bEnt into a discrete electrical setpoint power (PDis0 . . . PDisi . . . PDisn) for the drive train, for which control maps are stored in the operating strategy. In the conversion, the following assignment specifications are provided.
bEnt=1: The nearest higher discrete setpoint power (PDisi+1) to the on-board setpoint power is output.
bEnt=2: The nearest lower discrete setpoint power (PDisi) to the on-board setpoint power is output.
bEnt=3: The highest discrete setpoint power PDisn is output.
bEnt=4: The lowest discrete setpoint power Pdis0 is output.

The operating strategy undertakes the loading of signal bEnt, taking into consideration the charge condition of the battery, the driving situation, or the level of the on-board system voltage.

b) An optimal transmission ratio uGtr is determined from the family of shift maps as a function of the input variables, vehicle speed vFzg, desired torque Mawl and discrete setpoint power Pdis.

c) A higher-level ratio release, which prevents shifting during cornering, double shifting, etc., releases the optimal transmission ratio uGtr.

d) The characteristic map associated with discrete setpoint power PDis and transmission ratio uGtr is selected from the families of control maps of the combustion engine, and the appropriate setpoint operating points of the combustion engine are read out for continuous input variables vFzg and MAwl.

e) The setpoint operating points of the electrical machines are able to be determined from the setpoint operating points of the combustion engine as a function of the coupling conditions of the drive train.

The on-board power demand may be carried out analogously when it is not mapped to a discrete raster.

In addition, the discretizer may be controlled as a function of the battery charge condition. Then, for example, in response to a heavily charged battery, the nearest discrete setpoint power PDisi lower than the continuous power demand and, in response to a heavily discharged battery, the nearest higher setpoint power PDisi+l are output.

In addition, the discretizer may also be controlled as a function of the on-board voltage. Then, for example, in response to a high on-board voltage, the nearest discrete setpoint power PDisi lower than the continuous power demand and, in response to a low on-board voltage, the nearest higher setpoint power PDisi+l are output.

Finally, the discretizer may also still be controlled as a function of the driving situation. For example, following a long uphill drive, the nearest setpoint power PDisi lower than the continuous power demand (allows for regeneration of braking energy) and, in city traffic or in stop-and-go situations, the nearest higher setpoint power PDisi+l are output.

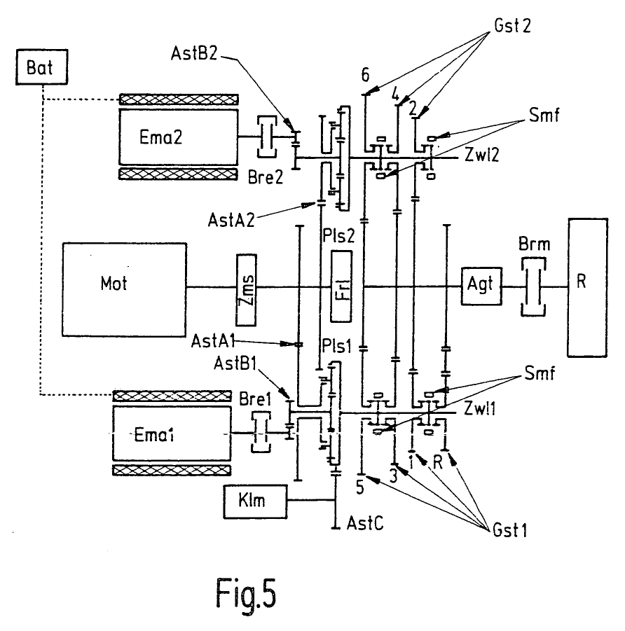

FIG. 5 schematically illustrates a drive train whose operating point may be set by employing the method according to the present invention. The two electrical machines Ema1 and Ema2 are connected to a battery Bat via which they are supplied with electrical energy. Each of the two electrical machines Ema1 and Ema2 is coupled via one machine brake Bre1, Bre2, respectively, gear-ratio steps Gst1 and Gst2, respectively, axle drive Agt and wheel brake Brm to a wheel R. The same applies in principle to combustion engine Mot, as well, which is also coupled, however, to a freewheeling clutch Frl and a dual-mass flywheel Zms. Finally, a compressor Kim is also provided for the air-conditioning system which is connected via a decoupling stage AstC to the drive train. Reference numerals AstB1 and AstB2 characterize the decoupling stages of electrical machines Ema1 and Ema2. On the other hand, reference numerals AstA1 and AstA2 characterize the decoupling stages of combustion engine Mot. Zwl1 and Zwl2 denote the intermediate shafts.

1-11. (canceled)

12. A method for setting an operating point of a drive train whose purpose is to provide a mechanical and an electrical power output, the method comprising:
selecting an appropriate characteristic map from a plurality of characteristic maps on the basis of a required electrical power; and
as a function of the characteristic map, selecting the operating point on the basis of a plurality of at least one of kinematic and dynamic degrees of freedom.

13. The method according to claim 12, wherein a control for an energy storage device of an on-board electrical system supplies a parameter which is indicative of a condition of the energy storage device, and the appropriate characteristic map is additionally selected on the basis of the parameter.

14. The method according to claim 13, wherein, in order to determine the required electrical power of the on-board electrical system, an electrical power required by power consumers and an electrical power one of demanded from and deliverable by the energy storage device are taken into consideration.

15. The method according to claim 14, further comprising one of charging and discharging the energy storage device as a function of the characteristic map.

16. The method according to claim 13, further comprising assigning the required electrical power of the on-board electrical system to a power stage, on whose basis the appropriate characteristic map is selected.

17. The method according to claim 16, wherein the power stage is additionally selected on the basis of at least one of the condition of the energy storage device of the on-board electrical system and a level of an available voltage.

18. The method according to claim 12, wherein the method is performed in a motor vehicle.

19. The method according to claim 18, wherein a first degree of freedom is constituted of a variable that represents a speed of the motor vehicle.

20. The method according to claim 12, wherein a second degree of freedom is constituted of a setpoint torque.

21. The method according to claim 12, wherein the drive train has a transmission, and a ratio of the transmission is controlled.

22. The method according to claim 12, wherein the drive train has an electric drive and an internal combustion drive, at least one of a torque and a speed of the internal combustion drive is specified, and at least one of a torque and a speed of the electric drive is specified.
